(19) United States
(12) Patent Application Publication
(10) Pub. No.: US 2024/0043273 A1
(43) Pub. Date: Feb. 8, 2024

(54) METHOD FOR PRODUCTION OF H2 WITH HIGH CARBON CAPTURE RATIO AND EFFICIENCY

(71) Applicant: SINTEF TTO AS, Trondheim (NO)

(72) Inventors: David BERSTAD, Trondheim (NO); Julian STRAUS, Trondheim (NO)

(21) Appl. No.: 18/266,418

(22) PCT Filed: Dec. 15, 2021
(86) PCT No.: PCT/NO2021/050264

§ 371 Date: Jun. 9, 2023

(30) Foreign Application Priority Data
Dec. 17, 2020 (NO) 20201387

(51) Int. Cl. C01B 3/48; C01B 3/50

(52) U.S. Cl. CPC C01B 3/48; C01B 3/505; C01B 3/508; C01B 2203/0244; C01B 2203/0288; C01B 2203/0405; C01B 2203/1241; C01B 2203/043; C01B 2203/148; C01B 2203/86

(57) ABSTRACT

The present invention relates to a method for production of H₂ from natural gas, solid fossil fuels or biomass. The method comprises the following steps: reacting natural gas in a reformer or reacting solid fossil fuels or biomass in a gasifier to form syngas, reacting the syngas to form a shifted gas mixture, comprising H₂ and CO₂, in a water-gas-shift (WGS) section, separating the shifted gas mixture into a H₂ gas and a H₂ depleted tail gas mixture or retentate gas mixture in a H₂ separation unit, separating the H₂-depleted tail gas mixture or retentate gas mixture into a CO₂ liquid and a CO₂-depleted tail gas mixture in a CO₂ capture and liquefaction unit, and recycling the CO₂-depleted tail gas mixture from the CO₂ capture and liquefaction unit without recompression to the WGS section and to the reformer or the gasifier. The CO₂-depleted tail gas mixture is at a pressure in the range from 25 to 120 bar when recycled to the WGS section and to the reformer or the gasifier.

### TECHNICAL FIELD

The present invention relates to a method for production of hydrogen (H₂) from natural gas, solid fossil fuel sources or biomass combined with carbon dioxide (CO₂) sequestration.

### BACKGROUND/PRIOR ART

Hydrogen production from solid fossil fuels and biomass starts with production of synthesis gas (syngas), a mixture of CO, CO₂, H₂O, and H₂. The production of synthesis gas involves reforming of natural gas or gasification of solid fossil fuel sources, such as coal, or biomass. Reforming can be furthermore conducted in a steam methane reformer (SMR), an autothermal reformer (ATR), or a gas heated reformer (GHR). Other variants such as sorption-enhanced reforming exist in addition.

The syngas from the reformer or the gasifier is shifted to a gas mixture containing H₂ and CO₂ in a water-gas-shift (WGS) reactor, and both the H₂ and the CO₂ are selectively separated in separation processes. The order of the separation processes is depending on the chosen separation technologies. Several separation processes are known for H₂, such as the use of membrane modules with palladium or palladium-alloy membranes (Pd-membranes) and the use of pressure swing adsorption (PSA).

Similarly, purification and capture of CO₂ from the gas mixture may be carried out with many different processes with chemical absorption processes being the most prominent. Alternatively, the gas mixture may be subjected to CO₂ liquefaction which consists of a series of compression stages and cooling to condense the CO₂.

Both separation steps can also be combined into a single separation step like vacuum pressure swing adsorption (VPSA).

The remaining tail gas after the H₂ and CO₂ separation steps is rich in CO and methane, and this tail gas is normally burned for production of high temperature heat for the process and reduction of CO and methane emissions. It is for both ATR, GHR, and gasifiers the key source for CO₂ emissions due to:
1. remaining CO that was not converted in the WGS reactor, and
2. remaining CO₂ from the separation process.
   One key problem of existing technologies is the low pressure of the CO rich tail gas after both separation processes. Hence, recycling of material streams is avoided due to both capital costs and energy requirements. This leads to the problem that all unconverted CO leaving the WGS reactor will eventually be emitted as CO₂ instead of being utilized for further H₂ production. Furthermore, high CO₂ capture ratios can only be achieved through comprehensive CO₂ separation processes corresponding to a large energy demand and capital investment, particularly large marginal energy demand and capital investment.

One object of the present invention is to provide a method for production of H₂ from natural gas, solid fossil fuels and biomass with a high CO₂ capture ratio. A further object is to improve the efficiency of the H₂ production process simultaneously.

### SHORT SUMMARY OF THE INVENTION

The present invention is conceived to solve or at least alleviate the problems identified above.

The present invention provides a method for production of H₂ from natural gas, solid fossil fuel sources or biomass, comprising the following steps:
reacting natural gas in a reformer or reacting solid fossil fuels or biomass in a gasifier to form syngas,
reacting the syngas to form a shifted gas mixture, comprising H₂ and CO₂, in a water-gas-shift (WGS) section,
separating the shifted gas mixture into a H₂ gas and a H₂ depleted tail gas mixture or retentate gas mixture in a H₂ separation unit,
separating the H₂-depleted tail gas mixture or retentate gas mixture into a CO₂ liquid and a CO₂-depleted tail gas mixture in a CO₂ capture and liquefaction unit,
recycling the CO₂-depleted tail gas mixture from the CO₂ capture and liquefaction unit without recompression to the WGS section and to the reformer or the gasifier; the CO₂-depleted tail gas mixture being at a pressure in the range from 25 to 120 bar when recycled to the WGS section and to the reformer or the gasifier.

The method may further comprise
compressing the H₂-depleted tail gas mixture or retentate gas mixture in at least one compressor,
cooling the H₂-depleted tail gas mixture or retentate in at least one heat exchanger,
separating a CO₂-rich liquid product from the H₂-depleted tail gas mixture or retentate gas mixture in a bulk separator at a bulk separation pressure in the range from 35 to 120 bar, and
purifying the CO₂-rich liquid product in at least one flash separation stage at a pressure level lower than that of the bulk separator.

In an embodiment of the invention, the H₂ separation unit is a pressure swing adsorption (PSA) unit, and the H₂-depleted tail gas mixture is subjected to multistage compression with interstage cooling to a pressure in the range 35-120 bar, before entering the at least one heat exchanger in the liquefaction unit. Remaining water of the H₂-depleted tail gas mixture will be removed during the multistage compression.

In another embodiment, the H₂ separation unit is a membrane module, wherein the shifted gas mixture is fed to a palladium or palladium-alloy or other hydrogen-conducting membrane where hydrogen permeates through the membrane, and the H₂-depleted retentate gas is compressed to 35-120 bar and dehydrated before entering at least one heat exchanger in the CO₂ liquefaction unit.

In addition to internal heat recovery, further cooling of the H₂-depleted gas retentate may be conducted with at least one refrigeration cycle using a at least one single-component or mixed-component refrigerant.

The CO₂-rich liquid product is purified in at least one flash separation unit, and a gas stream from at least one flash separation unit is recycled and mixed with CO₂-rich gas mixture originating from the H₂ separation unit.

Each bulk separator stage and flash separation stage can be made up of two or more parallel separators.

The WGS section comprises at least one WGS reactor. In the case the WGS section comprises more than one WGS reactor in series, the recycle flow is sent to the last WGS reactor.

The reformer may be selected from autothermal reformers or a combination of autothermal reformers and gas heated reformers, wherein the required heat of reaction is provided inside the autothermal reformers through a combustion reaction. Alternatively, the reformer may be a H₂ fuelled steam methane reformer.

The CO₂-rich liquid product from the at least one flash separation unit may be extracted and transmitted to one or more storage tanks or transport tanks. The CO₂-rich liquid product may be pressurised by a pump and subsequently heated and transmitted to a pipeline. The CO₂-rich liquid product may further be pressurised by a pump after heating, before being transmitted to a pipeline.

### FIGURES

FIG. 1 is a schematic view of a process flow diagram for natural gas as feedstock and oxygen-blown autothermal reforming as reforming process

FIG. 2 is a schematic view of a process configuration for low-temperature CO₂ capture from PSA tail gas and recovery and free-flow recirculation of CO₂-depleted tail gas. The process is configured to deliver high-purity CO₂ in liquid form for low pressure storage and transport.

FIG. 3 is a schematic view of another process configuration for low-temperature CO₂ capture from PSA tail gas and recovery and free-flow recirculation of the CO₂-depleted tail gas. The process is configured to deliver high-purity, high-pressure, sub- or supercritical CO₂ for pipeline transport.

FIG. 4 is a schematic view of a process configuration for low-temperature CO₂ capture from hydrogen-conducting membrane retentate gas, including recovery and free-flow recirculation of the CO₂-depleted tail gas. The process is configured to deliver high-purity CO₂ in liquid form for low pressure storage and transport.

FIG. 5 is a schematic view of a process configuration for low-temperature CO₂ capture from hydrogen-conducting membrane retentate gas, including recovery and free-flow recirculation of the CO₂-depleted tail gas. The process is configured to deliver high-purity, high-pressure, sub- or supercritical CO₂ for pipeline transport.

FIG. 6 is a graph illustrating the energy efficiency, both lower heating value LHV (right Y-axis) and higher heating value HHV (left Y-axis) as a function of tail gas recycle. “Total” corresponds to the division of all energy leaving the process by all energy entering the process, including electricity demand or production. “Thermal” corresponds to the division of the energy in the hydrogen product by the energy in the natural gas feed. The arrows on the lines point to the relevant axis.

FIG. 7 is a graph showing the calculated carbon capture ratio as a function of tail gas recycle, accounting for all carbon entering and leaving the system.

FIG. 8 is a graph showing the source of the emitted (uncaptured) CO₂ differentiating between stream number 105 (water knockout before the PSA unit) and stream number 126 (furnace gas), and also allocated to chemical components (CO, CO₂ and CH₄).

FIG. 9 is a graph illustrating the molar composition of the partially recycled tail gas from the CO₂ capture process, that is in streams 126, 127 and 128, as function of tail gas recycle ratio. The left y-axis is to be used for hydrogen, (the H₂-line is marked with an arrow to the left) while the right y-axis is to be used for the other chemical components; N₂, CO, CO₂ and CH₄ (marked with arrows to the right).

### DETAILED DESCRIPTION OF THE INVENTION

The present invention relates to H₂ production starting from natural gas, solid fossil fuel sources or biomass. Different conventional technologies may be used for production of syngas depending on the feedstock. Different H₂ separation technologies may also be used. In the present invention, CO₂ is separated by using a low-temperature CO₂ capture and liquefaction unit. The use of low temperature CO₂ liquefaction as CO₂ sequestration technology in combination with H₂ separation technology allows recycling of a CO₂ depleted tail gas from the CO₂ capture and liquefaction unit to the water-gas shift reactor (WGS) and the reformer or gasifier at the same or higher pressure than the operating pressure of the WGS reactor and reformer. This enables free-flow recycling of the tail gas. No additional, ancillary compressors are required. The CO₂ depleted tail gas is rich in CO, considerably richer than the CO concentration in product streams from the WGS reactor and further comprises unreacted methane from the reformer/gasifier, inert nitrogen and residual, unseparated fractions of CO₂ and H₂.

The composition of the CO₂-depleted tail gas is highly dependent on the degree of recycling from the bulk separator back to the WGS and reformer/gasifier reactors.

Typical concentrations of key components of the tail gas are:
CO: 5-25 mole %,
CH₄: 3-25 mole %,
H₂: 30-80 mole %,
CO₂: 10-25 mole %
and a balance of nitrogen and residuals.

A high fraction of the CO₂-depleted tail gas mixture is recycled, typically 60-90%, but preferably beyond this interval, preferably in the range 80-98%, with the remainder of the flow, from 0-30%, sent to a furnace for combustion/heat and steam generation. The recycled flow is channeled to the at least one WGS reactor and/or the reformers or gasifiers. The main portion of the recycle flow, from 60-90%, is preferably sent to the at least one WGS reactor. When a WGS section contains more than one WGS reactor, the recycle flow is sent to the last WGS. Typically, 70% of the recycled flowrate, but possibly higher or lower is sent to the WGS. A fraction of the recycle flow, from 10-40% is recycled to the reformer/gasifier. The recycled streams are normally pre-heated to match the reactor inlet temperatures of the main reactor feed streams. The advantage of recycling is given by the increased conversion of both CO and methane to finally CO₂, and hence, the potential for an increased carbon capture ratio.

The invention is especially beneficial for a reformer or gasifier in which the heat for the reaction is provided inside at least one reactor, that is, the required of heat reaction is not achieved through combustion outside the reactor. That corresponds to autothermal reformer, a combination of autothermal reformer and gas heated reformers and gasifiers. The advantage with these types of reactors is that all produced CO₂ is present in the stream entering the water-gas shift reactor increasing the carbon capture ratio. Alternatively, hydrogen fuelled steam methane reformer can also be used for achieving the high carbon capture ratio.

Embodiments of the invention will now be described with reference to the drawings.

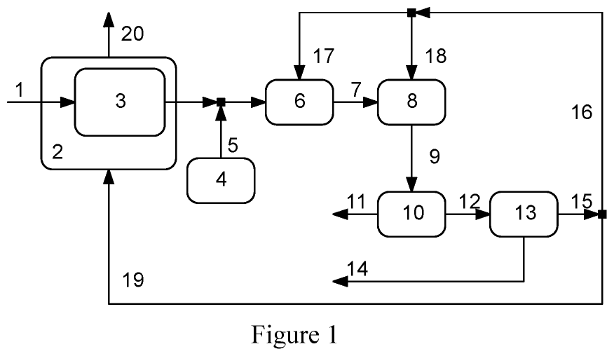

FIG. 1 shows an overview of the process flow diagram for one embodiment where natural gas is used as feedstock although the invention is not restricted to syngas from natural gas reforming.

Initially, natural gas feedstock 1 is supplied to a prereformer 3 where higher hydrocarbons (C₂-C₅) in the natural gas are reacted with steam to produce methane, CO and H₂. The heat for heating feed 1 is provided using a furnace 2 where the exhaust 20 is emitted to the environment.

The partially reformed gas is then fed together with steam (not shown in the figure) and oxygen 5, originating in this embodiment from an air separation unit 4 to an ATR 6 to convert the methane and other reactants to CO, CO₂, and H₂. In the present invention, a stream 17 corresponding to a fraction of the tail gas from the CO₂ capture and liquefaction unit 13 may be recycled to the ATR 6 to utilize unreacted methane. Subsequently, more H₂ is produced in the WGS section 8 through the WGS reaction in which CO and steam in the syngas 7 are converted to CO₂ and H₂. The number of WGS reactors of the WGS section 8 is a design parameter as a large number may improve the conversion of CO, while a smaller number reduces the investment costs. In the present invention, an additional inlet stream 18 corresponding to a fraction of the tail gas from the CO₂ separation section 13 is preferably added to the last WGS reactor, when more than one WGS reactor are utilized, due to its composition.

The shifted syngas 9 leaving the WGS section 8 is then separated into a H₂ stream 11 and a H₂-depleted mixture 12 in the hydrogen separation unit 10. CO₂ separation from the H₂-depleted mixture is in the present invention conducted by condensing the CO₂ at low temperature in a CO₂ capture and liquefaction unit 13 resulting in a CO₂ stream 14. This is the most rational way to separate CO₂ for gas mixtures with relatively high CO₂ concentrations, particularly for the H₂/CO₂ (syngas) systems.

The tail gas from CO₂ capture and liquefaction unit 13, stream 15, is first split into a recycle stream 16, which in turn is split into the recycle feed 17 to ATR 6 and recycle feed 18 to the WGS section 8, and a purge stream 19 which is used as fuel in furnace 2 to heat the feed 1 to prereformer 3. The combustion products in exhaust 20 are the only CO₂ emissions of the process.

One technology for H₂ separation which may be used in the present invention is pressure swing adsorption (PSA), a conventional and proven technology. An alternative technology for H₂ separation is use of membrane modules including palladium or palladium-alloy membranes (hereinafter called Pd membranes), an emerging technology currently not fully scaled-up and commercialised.

From a separation product point of view, the key difference between the two technologies is in the pressure level of the product streams after separation. While PSA results in a low-pressure CO₂ rich stream 12 and a high pressure H₂ stream 11, Pd-membrane separation results in a high pressure CO₂ rich stream 12 and a low pressure H₂ stream 11 and therefore opposite H₂ and tail/retentate gas compression requirements.

In one embodiment of H₂ separation a Pd membrane is used. In this embodiment the shifted synthesis gas 9 is directly fed to a Pd membrane where H₂ permeates through the membrane to yield hydrogen stream 11. The membrane is permeable only to H₂. For a given temperature level, the flux across the membrane is a function of the partial pressure difference of H₂ across the membrane. A lower permeate pressure reduces the required size of the membrane module while a higher permeate pressure reduces the required subsequent H₂ compression. The permeate pressure is therefore an important design parameter that accounts for the aforementioned trade-off. The H₂ permeate pressure usually varies from 1 to 5 bar.

The pressure of the retentate gas mixture 12 depends on the reformer type used and is usually more than 20 bar. The retentate gas mixture 12 is first cooled down and condensed water is separated. The remaining water vapour is then removed using adsorptive dehydration. The H₂-depleted retentate gas is compressed in a retentate compressor and again cooled to below 40° C., preferably below 30° C., even more preferred below 20° C., before it enters the CO₂ capture and liquefaction unit. The H₂-depleted retentate gas mixture 12 is compressed to 35-120 bar and dehydrated before entering at least one heat exchanger in the CO₂ capture and liquefaction unit.

If pressure swing adsorption (PSA) is used for H₂ separation, the shifted synthesis gas mixture 9 is first cooled down to below 40° C., more preferably below 30° C., even more preferred below 20° C., and condensed to separate water. Subsequently, H₂ is separated using pressure swing adsorption. As the H₂-depleted tail gas mixture 12 from the pressure swing adsorption unit is at a pressure typically in the range 1-5 bar, it is necessary to compress the H₂-depleted tail gas mixture 12 in several compression steps with interstage cooling.

The H₂-depleted tail gas mixture 12 is compressed from the PSA tail gas discharge pressure to the bulk separation pressure (35-120 bar) in a multi-stage, intercooled compressor train.

If coal or biomass is utilized as feedstock, both the prereformer 3 and ATR 6 are substituted with a gasifier and potentially a process for cleaning the syngas 7 before feeding it to the water-gas shift (WGS) reactor 8.

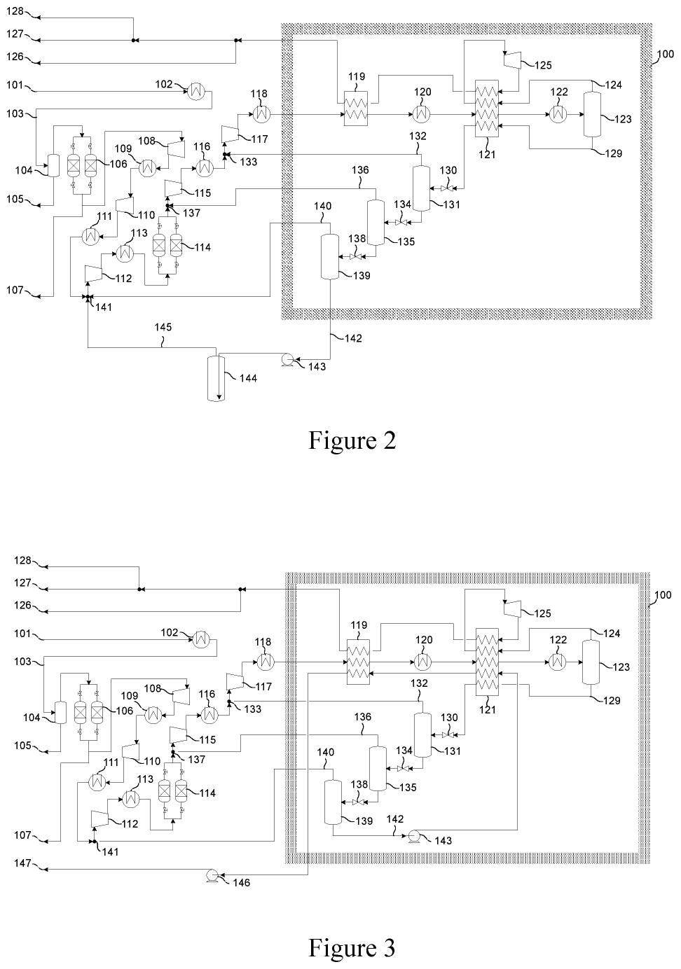

FIG. 2 shows a process flow diagram of one embodiment of the invention. The diagram shows the low-temperature CO₂ capture and liquefaction unit in the case of H₂ separation using pressure swing adsorption and delivery of CO₂ in liquid form at low pressure for bulk storage and transport.

In this embodiment, the process stream 101 leaving the WGS reactors is cooled to below 40° C., preferably below 30° C., even more preferred below 20° C. in heat exchanger 102, which causes condensation of a large fraction of the water content. The two-phase stream 103 is sent to water knock-out drum 104, removing the condensed water through stream 105. The condensed water still contains dissolved CO₂. The dried gas stream is the then fed to PSA unit 106 to separate H₂ in stream 107. The H₂-depleted tail gas from the PSA unit 106 is compressed (to about 70 bar) in five compression stages (compressors 108, 110, 112, 115, 117) with intercooling (coolers 109, 111, 113, 116, 118), and dehydrated in a desiccant bed 114 after intercooler 113, before entering the first low-temperature heat exchanger 119. The compressors upstream of the desiccant bed, thus operating in a potentially moist environment, can be fitted with suction-side scrubbers and demisters to prevent potential free-water carry-over. The compressed gas stream, which has been cooled to below 40° C., preferably below 30° C., even more preferred below 20° C., enters the coldbox 100 of the CO₂ capture and liquefaction unit where in this particular case it is cooled to around −51° C., but possibly higher or lower, by two internal heat recuperation heat exchangers 119 and 121 and two auxiliary refrigeration heat exchangers 120 and 122. After cooling, the major portion, about 93%, but possibly higher or lower depending on several conditions and design parameters, of CO₂ in the aggregate feed stream, along with minor portions of the other components, are condensed and separated from the gaseous phase in the bulk separation vessel 123. The CO₂-depleted gaseous phase (stream 124), from which the main fraction of CO₂ has been knocked out in liquid form (stream 129), may have a typical molar composition of around 58% H₂, 15% CO₂, 5% CH₄, 13% N₂ and 9% CO, however, the molar composition will vary from case to case since the composition depends on a range of variables. This stream is subsequently heated against the incoming feed stream in the recuperation heat exchangers 119 and 121. During this process, the stream in this particular case may also expanded in one embodiment to around 42 bar in a turbine 125, which induces a temperature drop of about 29° C., and passed twice through the recuperation heat exchanger 121. The appropriate expander outlet pressure and resulting temperature drop will depend on multiple variables such as, inter alia, bulk separation pressure level, temperature and resulting separation product stream compositions and flowrates, and can therefore be different than the particular aforementioned values. The expander outlet pressure is sufficiently high to allow free-flow recycle of part streams (i.e. streams 126, 127, 128) of the CO₂-depleted gas to the reactors and furnace located in the hydrogen production plant.

In other embodiments, the CO₂-depleted stream 124 is not expanded with a turbine, the reasons for which are, e.g., that the pressure levels of the reactors are higher, or that high valve authorities (pressure drop across control valve as a fraction of the total pressure drop in the recycle string) are needed when controlling recycle streams, or a combination of such reasons.

After heat recuperation against the incoming feed stream in heat exchangers 121 and 119, the stream is split into a furnace fuel stream 126 equivalent to about 10% of the flow rate, in other cases higher or lower, a recycle stream 127 to the final WGS reactor equivalent to about 63% of the flow rate, in other cases higher or lower, and a recycle stream 128 to the ATR reactor equivalent to about 27% of the flow rate, in other cases higher or lower. For the above-mentioned recycle stream ratio examples, the stream recycled to the WGS reactor is equivalent to about 9% of the main WGS feed stream in the hydrogen production plant on a molar flow basis. The corresponding stream recycled to the ATR reactor is equivalent to about 7% of the main ATR feed stream coming from the prereformer on a molar flow basis. The streams recycled to the reactors can be further heated to temperatures close to those of the respective WGS and ATR reactors. In the reactors, recycled CO is converted to CO₂ in the WGS reactor, and recycled CH₄ is reformed in the ATR reactors, which reduces the fractions of residual CO and CH₄ in the plant. Consequently, the overall hydrogen production rate and CO₂ capture rate are increased. The liquid CO₂ stream 129 from the bulk separator has a purity of approximately 95 mole %, but can be higher or lower depending on the conditions specified for the bulk separator, and is first heated (for example to around −16° C., in other cases higher or lower) against the incoming stream in heat exchanger 121. In other embodiments, this temperature can be both below and above this value as it will depend on multiple variables such as, inter alia, bulk separation pressure level, temperature and resulting separation product stream compositions and flowrates. After heating, the stream is subsequently expanded through valves 130, 134 and 138 and purified in three consecutive flash separators 131, 135 and 139.

The pressure levels of the first flash separator 131 and second flash separator 135 are in one embodiment approximately 37 bar and 17 bar, respectively. In this case the final flash separator 139 has a pressure of 6 bar (absolute). In other embodiments, the final flash pressure level can be 5.2-8 bar, depending on the specified CO₂ product conditions. The flash gas from all stages (streams 132, 136 and 140) are recycled to the compression section and mixed with compressor feed streams at matching pressure levels (mixing points 133, 137 and 141). In other embodiments the number of flash stages and attributed pressure levels can be different. In other embodiments, the cold flash gas streams 132, 136 and 140 can be heated (by auxiliary heating or heat integration with the main feed stream in recuperative heat exchangers similar to heat exchangers 119 and/or 121 to reduce the auxiliary refrigeration duties in the heat exchangers 120 and 122 and/or to eliminate any risk of local ice formation at those mixing points located upstream of the desiccant bed drying unit. In this embodiment, this applies to mixing point 141. The purity of the achieved liquid CO₂ stream 142 obtained in the final flash separator 139 is usually between 99.7% and 99.9%. In other embodiments the CO₂ liquid purity is usually in the range 99.0-99.9%, or higher.

The liquid temperature may be around −54° C. In other embodiments this temperature may be between −57° C. and −47° C.

In the embodiment shown in FIG. 2, the CO₂ product is meant for storage and bulk ship transport in liquid form, and the liquid CO₂ stream 142 is transferred from the final flash separator to one or more stationary storage vessels, ship tanks or similar (exemplified through tank 144), either by free-flowing transfer (induced by pressure and or gravitational differences) or aided by a transfer pump (pump 143) or similar device. Between the final separator vessel 139 and the CO₂ storage vessel or vessels 144, CO₂ may be transferred as saturated liquid, but can also be subcooled by liquid pumping by pump 143 to a higher pressure level, depending on conditions and needs related to long-term storage, transport and more. Boil-off from storage vessel or vessels 144 can be recycled through process stream 145 at matching pressure level in mixing point 141. In other embodiments with increased liquid pumping by pump 143, it can be recycled through mixing point 137.

FIG. 3 shows a process flow diagram of another embodiment of the invention. The diagram shows the low-temperature CO₂ capture and liquefaction unit in the case of H₂ separation using pressure swing adsorption and delivery of CO₂ in pressurised state for continuous pipeline transport. The process configuration is largely identical to that described in the embodiment above and shown in FIG. 2 but differs as the liquid CO₂ stream 142 from the last flash separator 139 is pumped to high pressure and heated against the incoming feed stream in heat exchanger 121 and 119. In this embodiment the pumping is done in two stages, one stage (pump 143) before and one stage (pump 146) after heating, but the pumping and pressurisation can also be fully provided before (all pressurisation by pump 143) heating in the recuperative heat exchangers 121 and 119. The final pressure in the CO₂ discharge stream 147 can be subcritical (i.e., below 73.8 bar) or supercritical (i.e., above 73.8 bar), depending on the specified transport state. The production of pressurised CO₂ for pipeline transport enables more internal heat recuperation since the CO₂ liquid product stream 142 from the final flash separator 139 can act as a heat sink in the recuperative heat exchangers 121 and 119, and therefore reduces the auxiliary refrigeration duty relative to that of the embodiment in FIG. 2.

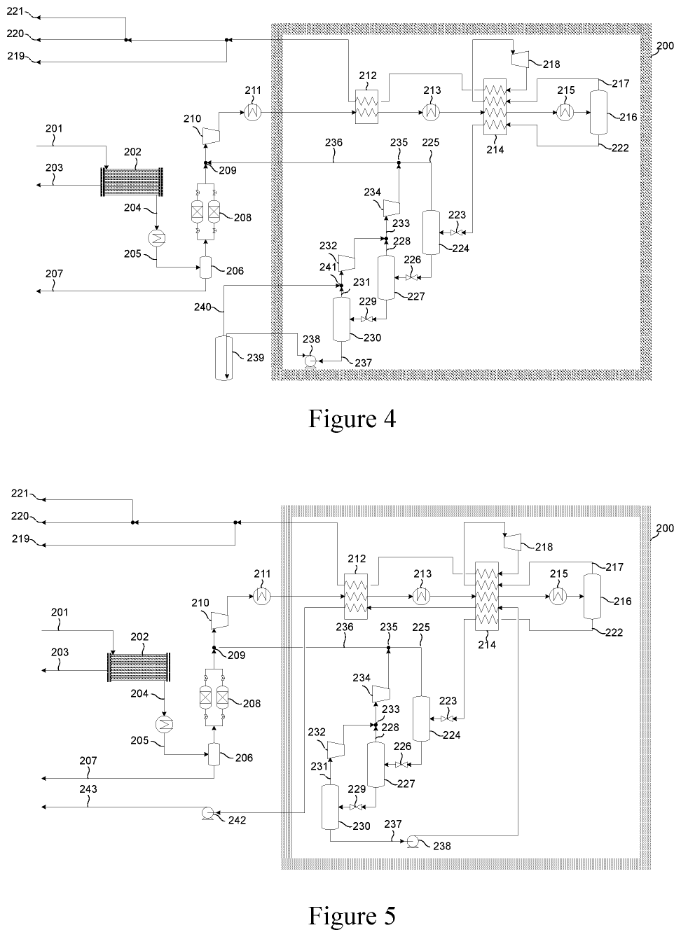

FIG. 4 shows a process flow diagram of another embodiment of the invention. This diagram shows the low-temperature CO₂ capture and liquefaction unit in the case of H₂ separation using Pd membranes. The captured CO₂ is delivered in liquid form at low pressure for bulk storage and transport.

In this embodiment, membrane module 202 splits the syngas feed stream 201 into a hydrogen permeate product 203 and a H₂-depleted retentate gas 204. The retentate stream is cooled to below 40° C., preferably below 30° C., even more preferred below 20° C., which causes condensation of a large fraction of the water content. The two-phase stream 205 is sent to water knock-out drum 206, removing the condensed water through stream 207. The remaining water fraction above levels which could otherwise cause water ice formation is removed in a desiccant bed 208, before it is mixed with recycle stream 236 in mixing point 209 and compressed to about 57 bar in compressor 210 followed by aftercooling in heat exchanger 211. After compression and cooling to below 40° C., preferably below 30° C., even more preferred below 20° C., the stream enters the coldbox 200 of the CO₂ capture and liquefaction unit where it in this particular case is cooled to around −47° C., but in other cases higher or lower, by two internal heat recuperation heat exchangers 212 and 214 and two auxiliary refrigeration heat exchangers 213 and 215.

After cooling, a major portion, about 90%, but possibly higher or lower depending on several conditions and design parameters, of CO₂ in the aggregate feed stream, along with minor portions of the other components, are condensed and separated from the gaseous phase in the bulk separation vessel 216. The CO₂-depleted gaseous phase stream 217, from which the main fraction of CO₂ has been knocked out in liquid form (stream 224), may have a molar composition of around 49% H₂, 20% CO₂, 6% CH₄, 14% N₂ and 11% CO, but will vary from case to case since the composition depends on a range of variables. This stream is subsequently heated against the incoming feed stream in the recuperation heat exchangers 214 and 212. During this process, the stream is in this particular case also expanded to 42 bar in a turbine 218, which induces a temperature drop of about 22° C., and passed twice through the recuperation heat exchanger 214. The appropriate expander outlet pressure and resulting temperature drop will depend on multiple variables such as, inter alia, bulk separation pressure level, temperature and resulting separation product stream compositions and flowrates, and can therefore be different than the particular aforementioned values. The expander outlet pressure is sufficiently high to allow free-flow recycling of part streams (i.e. streams 219, 220, 221) of the CO₂-depleted gas to the reactors and furnace located in the hydrogen production plant.

In other embodiments, the CO₂-depleted stream 217 is not expanded with a turbine, the reasons for which are, e.g., that the pressure levels of the reactors are higher, or that high valve authorities (pressure drop across control valve as a fraction of the total pressure drop in the recycle string) are needed when controlling recycle streams, or a combination of such reasons.

After heat recuperation against the incoming feed stream in heat exchangers 214 and 212, the stream is split into a furnace fuel stream 219 equivalent to about 10% of the flow rate, in other cases higher or lower, a recycle stream 220 to the final WGS reactor equivalent to about 63%, in other cases higher or lower, of the flow rate and a recycle stream 221 to the ATR reactor equivalent to about 27% of the flow rate, in other cases higher or lower. For the above-mentioned recycle stream ratio examples, the stream recycled to the WGS reactor is equivalent to about 8% of the main WGS feed stream in the hydrogen production plant on a molar flow basis. The corresponding stream recycled to the ATR reactor is equivalent to about 7% of the main ATR feed stream coming from the prereformer on a molar flow basis. The streams recycled to the reactors can be further heated close to temperatures of the respective WGS and ATR reactor. In the reactors, recycled CO is converted to CO₂ in the WGS reactor, and recycled CH₄ is reformed in the ATR reactors, which reduces the fractions of residual CO and CH₄ in the plant. Consequently, the overall hydrogen production rate and CO₂ capture rate are increased. The liquid CO₂ stream 222 from the bulk separator has a purity of approximately 95 mole %, but can be higher or lower depending on the conditions specified for the bulk separator, and is first heated to −24° C. against the incoming stream in heat exchanger 214. In other embodiments, this temperature can be both below and above this value as it will depend on multiple variables such as, inter alia, bulk separation pressure level, temperature and resulting separation product stream compositions and flowrates. After heating, the stream is subsequently expanded through valves 223, 226 and 229 and purified in three consecutive flash separators 224, 227 and 230.

The pressure levels of the first flash separator 223 and second flash separator 227 are approximately 35 bar and 14 bar, respectively. The final flash separator 230 has a pressure of 6 bar (absolute). In other embodiments, the final flash pressure level can be 5.2-8 bar, depending on the specified CO₂ product conditions. The flash gas stream 231 is compressed by a compressor 232 and thereafter mixed with flash gas stream 228. The mixed stream 233 is further compressed in compressor 234 and thereafter mixed with flash gas stream 225. The aggregated stream 236 from mixing point 235 is recycled and mixed with the incoming feed stream in mixing point 209. In other embodiments the number of flash stages and attributed pressure levels can be different.

The purity of the achieved liquid CO₂ stream 237 obtained in the final flash separator 230 is usually between 99.7% and 99.9%. In other embodiments the CO₂ liquid purity is usually in the range 99.0-99.9%, or higher. The liquid temperature may be around −54° C. In other embodiments this temperature may be between −57° C. and −47° C. In this embodiment, the CO₂ product is meant for storage and bulk ship transport in liquid form, and the liquid CO₂ stream 237 is transferred from the final flash separator to one or more stationary storage vessels, ship tanks or similar (exemplified through tank 239), either by free-flowing transfer (induced by pressure and or gravitational differences) or aided by a transfer pump 238 or similar device. Between the final flash separator 230 and the CO₂ storage vessel or vessels 239, CO₂ may be transferred as saturated liquid, but can also be subcooled by liquid pumping by pump 238 to a higher pressure level, depending on conditions and needs related to long-term storage, transport and more. Boil-off from storage vessel or vessels 239 can be recycled through process stream 240 at matching pressure level in mixing point 241. In other embodiments with increased liquid pumping by pump 239, it can be recycled through mixing with stream 228.

FIG. 5 shows a process flow diagram of another embodiment of the invention. The diagram shows the low-temperature CO₂ capture and liquefaction unit in the case of H₂ separation using Pd-membranes and delivery of CO₂ in pressurised state for continuous pipeline transport. The process configuration is largely identical to that described in the embodiment above and shown in FIG. 4, but differs as the liquid CO₂ stream 237 from the last flash separator 230 is pumped to high pressure and heated against the incoming feed stream in heat exchanger 214. In this embodiment the pumping is done in two stages, one stage (pump 238) before and one stage (pump 242) after heating, but the pumping and pressurisation can also be fully provided before (all pressurisation by pump 238) heating in the recuperative heat exchangers 214 and 212. The final pressure in the CO₂ discharge stream 243 can be subcritical (i.e. below 73.8 bar) or supercritical (i.e. above 73.8 bar), depending on the specified transport state. The production of pressurised CO₂ for pipeline transport enables more internal heat recuperation since the CO₂ liquid product stream 237 from the final flash separator 230 can act as a heat sink in the recuperative heat exchangers 214 and 212, and therefore reduces the auxiliary refrigeration duty relative to that of the embodiment in FIG. 4.

The number of compressor stages may vary and depends on the process conditions. Lower tail gas or retentate pressure from the H₂ separation process increases the required number of compressor stages. Higher tail gas or retentate pressure from the H₂ separation process lowers the required number of compressor stages. Lower tail gas or retentate CO₂ concentration from the H₂ separation process increases the required number of compressor stages. Higher tail gas or retentate CO₂ concentration from the H₂ separation process lowers the required number of compressor stages. Higher targeted CO₂ cut in the low-temperature separation unit increases the required number of compressor stages. Lower targeted CO₂ cut in the low-temperature separation unit lowers the required number of compressor stages.

Examples of compressors used in the present invention are usually centrifugal compressors, but can also include rotary-screw compressors, piston compressors and axial compressors, dry-running or oil-injected with subsequent oil scrubbers. In the case of turbine expansion of the gaseous separation product from the bulk separator, expanders and compressors may be coupled by direct-drive shaft couplings.

The CO₂-depleted tail gas is recycled to the at least one WGS reactor, preferably to the final WGS reactor when the WGS section comprises more than one WGS reactor, and also a portion of the CO₂-depleted tail gas is recycled to the reformer or gasifier, without the use of additional dedicated compressors, since the tail gas pressure is kept higher than that of the WGS reactors and reformer or gasifier, thus enabling free-flow recycling. The pressure of the CO₂-depleted tail gas when recycled is at least 25 bar, preferably more than 40 bar and up to 120 bar.

Liquid CO₂ is separated from the CO₂ rich gas mixture in a single bulk separator at the highest pressure level, typically from 35-120 bar, and at low temperature, typically between −56 and −40° C., where the refrigeration is partly provided by auxiliary refrigeration. Preferably, the pressure of the H₂-depleted tail gas mixture or retentate gas mixture is at least 40 bar when entering the at least one bulk separator.

The amount of auxiliary refrigeration depends on the amount of internal thermal recuperation available from the cold product streams. This depends on several factors, e.g., the amount of CO₂ separated, the pressure level of the tail gas stream, pressure level of the reformer and WGS, and the final state of captured CO₂ (e.g., high-pressure gas, high-pressure liquid or dense-phase, medium-pressure liquid, low-pressure liquid).

The liquid CO₂ separated at the highest pressure level is close to the mixture's liquid equilibrium composition at the given temperature and pressure. The CO₂-rich liquid phase is therefore usually saturated with impurities such as H₂, N₂, CO, CH₄.

The actual point where CO₂ is finally removed from the process and sent to transport is usually in the liquid outlet of the final flash separation stage. Depending on the desired final state of CO₂, this stream may or may not be further processed. In the case of high-pressure CO₂, typical for sub- or supercritical pipeline transport states, the final liquid CO₂ stream can be pumped either before, after, or partly before and partly after heat integration with the CO₂ rich gas cooling process. For liquid CO₂ bulk transport, typically at pressures between 6 and 20 bar, the final liquid stream may be transported and/or stored in its current state, or it can be further subcooled at the current pressure by auxiliary refrigeration, or subcooled at higher pressure through liquid pumping with or without additional heating.

The expansion devices used in the stepwise cascade purification and process can be either isenthalpic throttling, expansion machines such as, but not limited to, turbo-expanders or a combination of isenthalpic throttling and expansion machines.

### EXAMPLES/EXPERIMENTAL

The process in this invention was modelled in Aspen HYSYS V9.6 using natural gas as feedstock and autothermal reforming as technology for reforming.

The reactors were modelled as equilibrium reactors. Heat integration was achieved through pinch analysis.

Table 1 shows the composition on dry basis (without steam) for one embodiment with only recycling to the WGS section (i.e., no recycling to the ATR) and a combination of a high temperature water-gas shift reactor (HT-WGS) and a low temperature water-gas shift reactor (LT-WGS). The stream “Feed from HT-WGS” is the same for both applied separation technologies (PSA and Pd membrane) and is mixed with the stream “Recycled tail gas” to form the stream “Mixed stream—Feed to LT-WGS”.

The CO₂-depleted recycled tail gas has a relatively high mole fraction of CO and a relatively low mole fraction of H₂ and/or CO₂ on a dry basis. This implies that mixing the feed from HT-WGS and recycled tail gas will result in a feed stream to the LT-WGS reactor with less CO₂ and hydrogen and more CO than in the case without tail gas recycling. Hence, it affects the equilibrium in the low temperature water-gas shift reactor positively and results in a higher extent of reaction than without tail gas recycling. This in turn results in a higher hydrogen production.

TABLE 1
Mole fraction in the dry streams (without steam) in %. All
processes utilize a high temperature water-gas shift reactor prior
to the low temperature water-gas shift reactor.

| | | PSA separation | | Pd membrane separation | |
|---|---|---|---|---|---|
| | | | Mixed | | Mixed |
| | Feed | | stream- | | stream- |
| Stream | from HT- | Recycled | Feed to | Recycled | Feed to LT- |
| Component | WGS | tail gas | LT-WGS | tail gas | WGS |
| CO | 7.7 | 7.9 | 7.7 | 8.0 | 7.8 |
| CO₂ | 21.8 | 15.1 | 20.8 | 20.2 | 21.5 |
| H₂ | 70 | 54 | 67 | 41 | 65 |

Table 2 shows key performance indicators for one embodiment of the invention in which tail gas is recycled to the low temperature water-gas shift reactor. It highlights that it is feasible to obtain high carbon capture rates independently of the hydrogen separation ratio.

TABLE 2
Results for different investigated cases with recycling to
LT-WGS and with no recycling to ATR.

| Parameter | Unit | PSA | Pd |
|---|---|---|---|
| Recirculation ratio | % | 88 | 91 |
| Carbon capture ratio | % | 96.38 | 96.08 |
| Energy efficiency, | % | 83.61 | 84.74 |
| higher heating value basis | | | |
| Energy efficiency, | % | 78.18 | 79.28 |
| lower heating value basis | | | |

Table 3 shows key performance indicators for one embodiment of the invention in which tail gas is recycled to both the low temperature water-gas shift reactor and an autothermal reactor showing the increased carbon capture ratio through recycle to the ATR while also slightly increasing the energy efficiency of the process. As the total recirculation rate is unchanged, it shows the benefit of splitting the recycle stream into two streams, one recycled to the ATR and one recycled to the WGS section.

TABLE 3
Results for the different investigated cases using PSA for
hydrogen separation and recycling to both ATR and LT-WGS.

| Parameter | Unit | | | |
|---|---|---|---|---|
| Recirculation ratio total | % | 88 | 88 | 88 |
| Recirculation to WGS* | % | 100 | 85 | 70 |
| Recirculation to ATR* | % | 0 | 15 | 30 |
| Carbon capture ratio | % | 96.38 | 97.08 | 97.33 |
| Energy efficiency, | % | 83.61 | 83.90 | 83.89 |
| higher heating value | | | | |
| Energy efficiency, | % | 78.18 | 78.45 | 78.45 |
| lower heating value | | | | |

*Fraction of the 88% recycled stream.

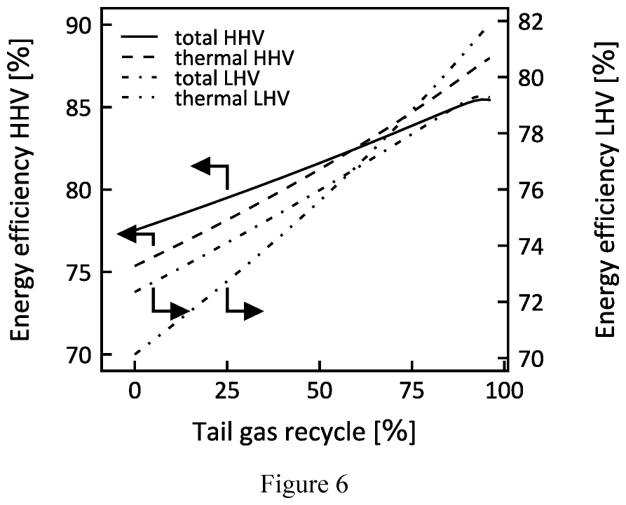

FIGS. 6 to 9 are illustrating key performance indicators with varying total tail gas recirculation ratios for one embodiment of the invention with an ATR, two water-gas shift reactors, and a recirculation ratio to the ATR of 25% as fraction of the recirculated tail gas.

FIG. 6 shows that a general recycle to both the ATR and the water-gas shift (WGS) reactor is beneficial for increased energy efficiency. This is independent of whether the total energy efficiency or the thermal energy efficiency is considered. The total energy efficiency is however levelling off at recirculation ratios of 95% or higher.

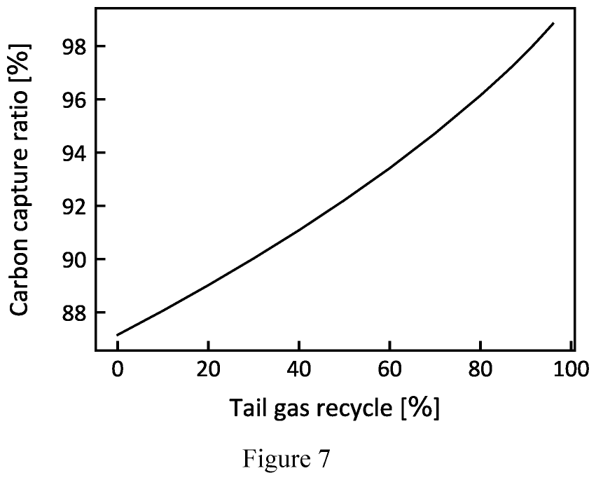

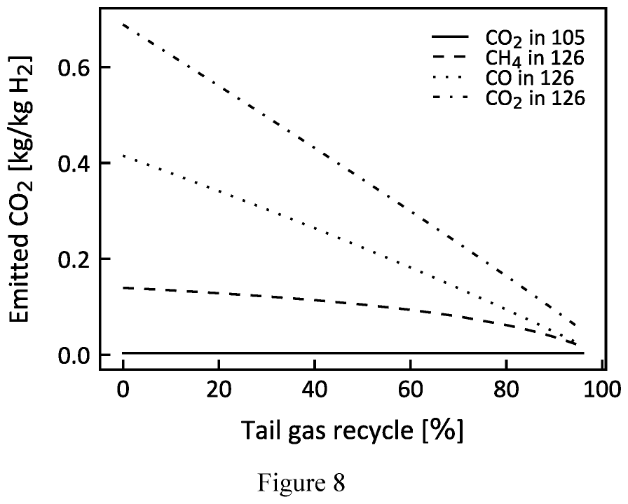

FIG. 7 shows that the recirculation allows the capture of additional CO₂. This additional CO₂ is caused through both a reduced flow rate in stream 127 in FIG. 2 and a higher conversion of CH₄ and CO. This is substantiated by FIG. 8 which illustrates the emitted CO₂ relative to the amount of produced hydrogen

(CO₂ intensity of hydrogen) for the different sources of CO₂. CO₂ in stream 105 corresponds to dissolved CO₂ in the separated water stream 105 after the water knock-out drum 104. CO and CH₄ in stream 126 correspond to the CO₂ produced through combusting both CO and CH₄ in a furnace. FIG. 8 shows that low CO₂ intensities of the produced hydrogen are only possible if the concentrations of both CO and CH₄ are reduced in stream 126 as achieved in this invention through recycling.

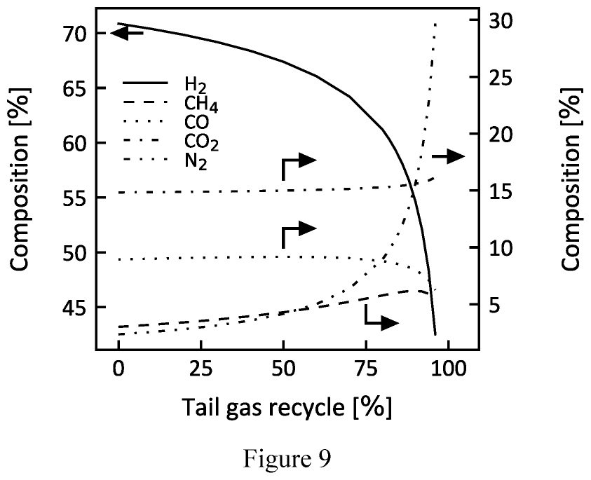

FIG. 9 illustrates that the recirculation:
1. does not affect the CO concentration in streams 126, 127 and 128 for low recirculation ratios, but reduces the CO concentration in said streams at higher ratios,
2. increases the CH₄ concentration in streams 126, 127 and 128 up to a recirculation ratio of around 90%, while reduces the CH₄ concentration at higher ratios,
3. reduces the hydrogen concentration in streams 126, 127 and 128 for all recirculation ratios but super linear for higher values,
4. rarely affects the CO₂ concentration in streams 126, 127 and 128, and
5. increases the N₂ concentrations in streams 126, 127 and 128, especially at higher recirculation ratios.

From statements 1 and 2, it can be concluded that the recirculation increases the conversion of both CO and CH₄. From statement 3, it can be concluded that, although not the main aim, recirculation also increases the total hydrogen recovery. Statement 4 shows that the increased carbon capture ratio is not due to a higher capture per pass. Statement 5 illustrates while a practical application may not allow a recycle ratio above a given ratio due to build-up of inert chemical species.

The terms recycle/recycling and recirculate/recirculation are to be considered synonymous.

Having described preferred embodiments of the invention it will be apparent to those skilled in the art that other embodiments incorporating the concepts may be used. These and other examples of the invention illustrated above are intended by way of example only and the actual scope of the invention is to be determined from the following claims.

1. A method for production of H₂ from natural gas, solid fossil fuels or biomass, comprising the following steps:
reacting natural gas in a reformer or reacting solid fossil fuels or biomass in a gasifier to form syngas,
reacting the syngas to form a shifted gas mixture, comprising H₂ and CO₂, in a water-gas-shift (WGS) section,
separating the shifted gas mixture into a H₂ gas and a H₂ depleted tail gas mixture or retentate gas mixture in a H₂ separation unit,
separating the H₂-depleted tail gas mixture or retentate gas mixture into a CO₂ liquid and a CO₂-depleted tail gas mixture in a CO₂ capture and liquefaction unit, and
recycling the CO₂-depleted tail gas mixture from the CO₂ capture and liquefaction unit without recompression to the WGS section and to the reformer or the gasifier; the CO₂-depleted tail gas mixture being at a pressure in the range from 25 to 120 bar when recycled to the WGS section and to the reformer or the gasifier.

2. The method according to claim 1, further comprising
compressing the H₂-depleted tail gas mixture or retentate gas mixture in at least one compressor,
cooling the H₂-depleted tail gas mixture or retentate in at least one heat exchanger,
separating a CO₂-rich liquid product from the H₂-depleted tail gas mixture or retentate gas mixture in a bulk separator at a bulk separation pressure in the range from 35 to 120 bar, and
purifying the CO₂-rich liquid product in at least one flash separation stage at a pressure level lower than that of the bulk separator.

3. The method according to claim 1, wherein the H₂ separation unit is a pressure swing adsorption (PSA) unit, and the H₂-depleted tail gas mixture is subjected to multistage compression with interstage cooling to a pressure in the range 35 to 120 bar, before entering at least one heat exchanger in the CO₂ capture and liquefaction unit.

4. The method according to claim 3, wherein remaining water of the H₂-depleted tail gas mixture is removed during the multistage compression.

5. The method according to claim 1, wherein the H₂ separation unit is a membrane module, wherein the shifted gas mixture is fed to a palladium or palladium-alloy or other H₂-conducting membrane where H₂ permeates through the membrane, and the H₂-depleted retentate gas mixture is compressed to 35-120 bar, and dehydrated before entering at least one heat exchanger in the CO₂ capture and liquefaction unit.

6. The method according to claim 1, wherein the CO₂-rich liquid product is purified in at least one flash separation unit, and a gas stream from at least one flash separation unit is recycled and mixed with the H₂-depleted gas mixture or retentate gas mixture originating from the H₂ separation unit.

7. The method according to claim 1, wherein the WGS section comprises at least one WGS reactor.

8. The method according to claim 1, wherein the WGS section contains more than one WGS reactor in series, and the recycle flow is sent to the last WGS reactor.

9. The method according to claim 1, wherein the reformer is selected from autothermal reformers or a combination of autothermal reformers and gas heated reformers, wherein the required heat of reaction is provided inside the autothermal reformers through a combustion reaction.

10. The method according claim 1, wherein the reformer is a H₂-fuelled steam methane reformer.

11. The method according to claim 1, wherein the CO₂-depleted tail gas mixture from the CO₂ capture and liquefaction unit comprises the following gas composition
CO: 5-25 mole %,
CH₄: 3-25 mole %,
H₂: 30-80 mole %,
CO₂: 10-25 mole %
and a balance of nitrogen and residuals.

12. The method according to claim 1, wherein a fraction of 60-90% of the CO₂-depleted tail gas mixture is recycled to the WGS section, a fraction from 10-40% of the CO₂-depleted tail gas mixture is recycled to the reformer or the gasifier, and a remaining fraction from 0-30% is sent to a furnace for combustion.
